(19) United States
(12) Patent Application Publication
(10) Pub. No.: US 2007/0146815 A1
(43) Pub. Date: Jun. 28, 2007

(54) IMAGE CAPTURING APPARATUS AND FOCUSING METHOD THEREOF

(75) Inventor: Lei Chen, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/562,434

(22) Filed: Nov. 22, 2006

(30) Foreign Application Priority Data
Dec. 26, 2005 (TW) 94146559

(51) Int. Cl. H04N 1/04

(52) U.S. Cl. 358/474

(57) ABSTRACT

An image capturing apparatus and a focusing method thereof are provided. The image capturing apparatus includes a flatbed, a light source, an optical sensing unit, a focusing unit and an adjuster medium. The flatbed is used for carrying an object. The light source is used for illuminating the object to output an optical signal. The optical sensing unit is used for sensing the optical signal to output an electrical image signal. The focusing unit is disposed between the flatbed and the optical sensing unit. The adjuster medium is configured between the object and the optical sensing unit for adjusting the object distance or the image distance, such that the focusing unit focuses the optical signal on the optical sensing unit to generate an electrical image signal.

This application claims the benefit of Taiwan application Ser. No. 94146559, filed Dec. 26, 2005, the subject matter of which is incorporated herein by reference.

### BACKGROUND OF THE INVENTION

1. Field of the Invention

The invention related in general to an image capturing apparatus and method, and more particularly to an image capturing apparatus applicable to different object distances and a focusing method thereof.

2. Description of the Related Art

Referring to FIG. 1, the imaging of a conventional contact image sensor (CIS) is shown. When scanning an image, the self-focus lens array 130 focuses the light reflected or penetrated from the document 160 on an optical sensor 120 first, and then the optical sensor 120 converts the light on the document 160 into an electrical signal to be outputted. Meanwhile, the distance between the document 160 and the optical sensor 120 is distance L0, the distance between the self-focus lens array 130 and the document 160 is object distance W, and the distance between the self-focus lens array 130 and the optical sensor 120 is image distance X. According to the characteristics of the self-focus lens array 130, for an image to be clearly formed, the object distance W must be equal to the image distance X.

The focusing unit and the image sensing system (CIS) are disadvantaged by having a shallow depth of field, which is approximately +/−0.3 mm. Therefore, when a document is to be scanned, the document must be placed on the surface of the flatbed without any gap, otherwise the image cannot be clearly formed. However, it the positive film or negative film to be scanned is carried on a film holder, a gap is generated between the object to be scanned and the scanning flatbed. Therefore, the current method of scanning the positive film or negative film carried on a film holder is incapable of generating quality image.

The U.S. Pat. No. 6,188,465 “Dual Depth-Of-Field Image Focusing System” incorporates two sets of lens arrays from which the user can select one appropriate lens array according to the depth of field of the document to be scanned, such that the fixed ratio between the object distance and the image distance is maintained and the image of the document is clearly formed. However, such design is costive because two sets of lens arrays are used. Furthermore, such design is only applicable to the scanning documents with two predetermined sets of depth of field and is not applicable to the scanning documents with multiple sets of depth of field.

### SUMMARY OF THE INVENTION

It is therefore an object of the invention to provide an image capturing apparatus applicable to different object distances and a focusing method thereof. The invention adopts an adjustable focusing unit incorporated by an adjuster medium, whereby the object distance or the image distance is adjusted and the object is clearly focused and imaged.

The invention achieves the above-identified object by providing an image capturing apparatus. The image capturing apparatus includes a flatbed, a light source, an optical sensing unit, a focusing unit and an adjuster medium. The flatbed is used for carrying an object. The light source is used for illuminating the object to output an optical signal. The optical sensing unit is used for sensing the optical signal to output an electrical image signal. The focusing unit is disposed between the object and the optical sensing unit. The adjuster medium is configured between the object and the optical sensing unit for adjusting the object distance or the image distance of the image capturing apparatus during focusing, such that the focusing unit focuses the optical signal on the optical sensing unit to generate the electrical image signal.

The invention further achieves the above-identified object by providing a focusing method of image capturing apparatus. The image capturing apparatus includes a flatbed, a light source, an optical sensing unit and a focusing unit. The focusing method of image capturing apparatus includes following steps. Firstly, the object is placed above the flatbed, wherein the object and the flatbed are spaced by a height d. Next, the adjuster medium is loaded between the object and the optical sensing unit for adjusting the object distance or the image distance. Then, the object is illuminated to output an optical signal by the light source. The optical signal passes through the focusing unit and the adjuster medium to be focused on the optical sensing unit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) illustrates the imaging of a conventional contact image sensor (CIS);

FIG. 2A illustrates an image capturing apparatus according to an embodiment of the invention in a first state;

FIG. 2B illustrates an image capturing apparatus in a second state according to a first embodiment of the invention;

FIG. 2C illustrates an image capturing apparatus in a second state according to a second embodiment of the invention;

FIG. 3 illustrates a flowchart of a focusing method of image capturing apparatus according to an embodiment of the invention;

FIG. 4 illustrates an optical path of an image capturing apparatus according to an embodiment of the invention;

FIG. 5A illustrates an adjuster medium with multiple sheets in an image capturing apparatus according to an embodiment of the invention; and

FIG. 5B illustrates an adjuster medium with ladder structure in an image capturing apparatus according to an embodiment of the invention.

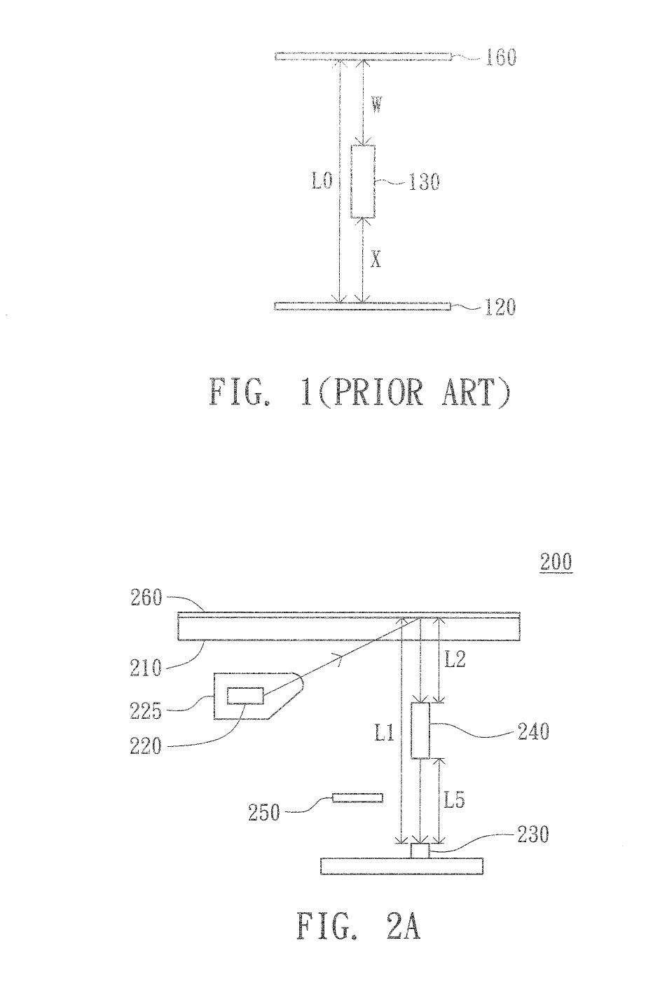

### DETAILED DESCRIPTION OF THE INVENTION

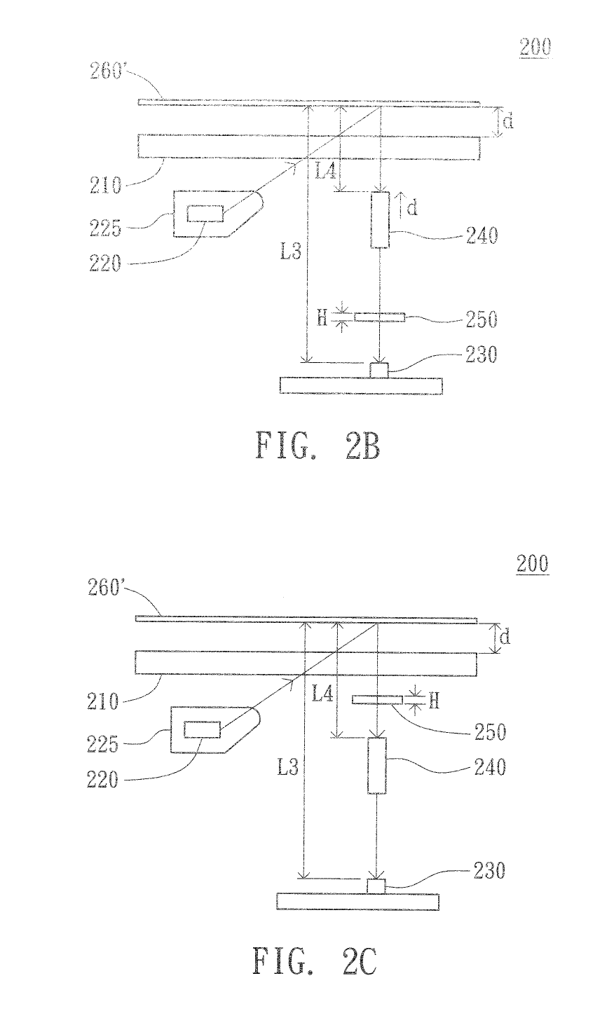

Referring to FIG. 2A, an image capturing apparatus according to an embodiment of the invention in a first state is shown. Under the state, the object 260 is seamlessly disposed on the flatbed 210. The image capturing apparatus 200 includes a flatbed 210, a light source 220, an optical sensing unit 230, a focusing unit 240 and an adjuster medium 250. The flatbed 210 is used for carrying an object 260. The light source 220 includes a light guiding element 225. The light guiding element 225 converts the point light source of the light source 220 into a uniform line light source for illuminating the object 260 to output an optical signal. The optical sensing unit 230 converts the sensed optical signal into an electrical image signal to be outputted. The optical signal forms an optical path between the object 260 and the focusing unit 240 first and the optical sensing unit 230 next. The focusing unit 240 is movably disposed in the optical path between the object 260 and the optical sensing unit 230 for receiving and automatically focusing the optical signal on the optical sensing unit 230 to generate the electrical image signal. When the object 260 is seamlessly placed on the flatbed 210, the optical sensing unit 230 and the object 260 are spaced by a first distance L1, the focusing unit 240 and the object 260 are spaced by a second distance L2, the focusing unit 240 and the optical sensing unit 230 are spaced by a fifth distance L5, wherein a fixed ratio k, such as 1 for instance, exists between the second distance L2 and the fifth distance L5. When the object 260 and the optical sensing unit 230 are spaced by a first distance L1, the adjuster medium 250 is disposed outside the optical path; meanwhile, the image of the object 260 can be focused on the optical sensing unit 230 to form a clear image. Referring to FIG. 2B and FIG. 2C, FIG. 2B is an image capturing apparatus in a second state according to a first embodiment of the invention, and FIG. 2C is an image capturing apparatus in a second state according to a second embodiment of the invention. Under the second state, there is a gap d existing between the object 260′ and the flatbed 210. When a gap d exists between the object 260′ and the flatbed 210, the optical sensing unit 230 and the object 260′ are spaced by a third distance L3, and the focusing unit 240 and the object 260′ are spaced by a fourth distance L4. When the object 260′ and the optical sensing unit 230 are spaced by a third distance L3, the adjuster medium 250 is disposed in the optical path, and the object 260′ and the focusing unit 240 are spaced by a fourth distance L4. The adjuster medium 250 is preferably made of glass or acryl. Examples of the focusing unit 240 include a self-focus lens array. Examples of the optical sensing unit 230 include a contact image sensor (CIS).

### First Embodiment

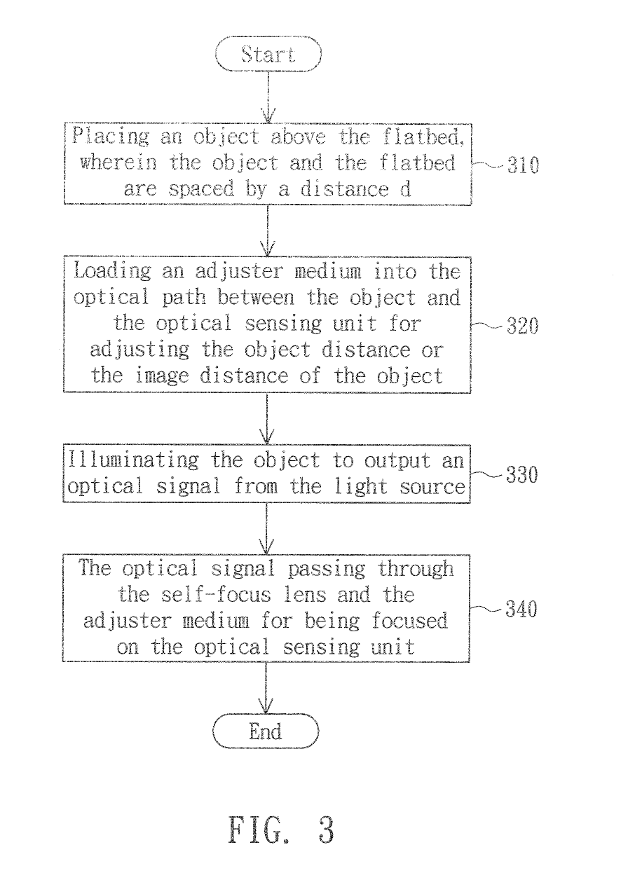

Referring to FIG. 2B and FIG. 3, FIG. 2B illustrated an image capturing apparatus in a second state according to a first embodiment of the invention. Under the second state, the object 260′ and the flatbed 210 are spaced by a distance d. FIG. 3 illustrates a flowchart of a focusing method of image capturing apparatus according to an embodiment of the invention.

Firstly, the focusing method of the image capturing apparatus begins at step 310. In step 310, an object 260′ is placed above the flatbed 210, and the object 260′ and the flatbed 210 are spaced by a distance d. Meanwhile, a fixed ratio k no longer exists between the object distance and the image distance, so the image can not be clearly formed. Next, proceeding to step 320, an adjuster medium 250 is loaded into the optical path between the object 260′ and the optical sensing unit 230 for adjusting the object distance or the image distance of the object 260′. The image capturing apparatus of the first embodiment of the invention forms a clear image by adjusting the image distance of the object 260′. Before the adjuster medium 250 is loaded, the focusing unit 240 is shifted upward from an initial position of FIG. 2A to an adjusting position of FIG. 2B by a distance d for adjusting the object distance of the object 260′, such that an adjusting object distance of the object 260′ is maintained at the second distance L2. As the focusing unit 240 is shifted upward, the image distance is changed, and the image distance is not longer equal to the fifth distance L5. As shown in FIG. 2B, the adjuster medium 250 is loaded into the optical path between the focusing unit 240 and the optical sensing unit 230 for adjusting the image distance of the object 260′, such that the focusable image distance of the object 260′ is equal to the fifth distance L5+d. Then, proceeding to step 330, the object 260′ is illustrated by the light source 220 to output an optical signal. Lastly, proceeding to step 340, the optical signal passes through the focusing unit 240 and the adjuster medium 250 to be focused on the optical sensing unit 230, and the focusing method according to the first embodiment of the invention is terminated.

In the first embodiment of the invention, the adjuster medium 250 is loaded into the optical path between the focusing unit 240 and the optical sensing unit 230 for adjusting the image distance. Thus, the light can be focused on the optical sensing unit 230, and the light on the object 260′ is converted into an electrical signal to be outputted by the optical sensing unit 230 to generate an electrical image signal. The adjuster medium 250 has a thickness H and a refractive index n, wherein thickness H, the refractive index n and height d satisfy: H*(1−1/n)=d, and the fifth distance L5 and height d satisfy: H≦L5+d.

### Second Embodiment

Referring to FIG. 2C and FIG. 3, FIG. 2C illustrates an image capturing apparatus in a second state according to a second embodiment of the invention. The image capturing apparatus of the second embodiment differs with the image capturing apparatus of the first embodiment in step 320. The image capturing apparatus of the second embodiment achieves clear imaging by directly adjusting the focusable object distance of the object 260′ without adjusting the focusing unit 240. As shown in FIG. 2C, the focusing unit 240 is maintained at the initial position, meanwhile, the image distance remains at the fifth distance L5, than the adjuster medium 250 is loaded into the optical path between the object 260′ and the focusing unit 240 for adjusting the object distance. Meanwhile, the focusable object distance of the object 260′ is equal to the second distance L2+d, and the light is enabled to be focused on the optical sensing unit 230. In the second embodiment of the invention, the focusing unit 240 does not have to be movable, and the thickness H, the refractive index n, and the distance d of the adjuster medium 250 satisfy: H*(1−1/n)=d, and the fourth distance L4 satisfies: H≦L4.

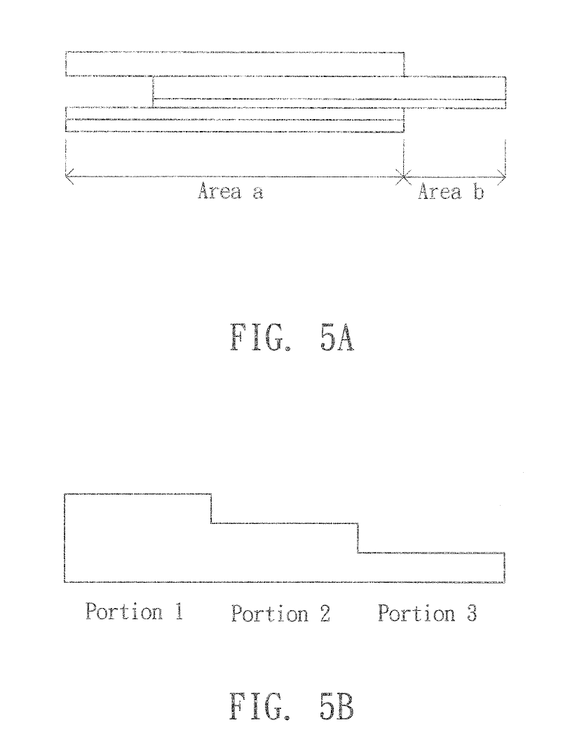

The adjuster medium disclosed above can be single-sheeted or multi-sheeted. Referring to FIG. 5A, an adjuster medium with multiple sheets of an image capturing apparatus according to an embodiment of the invention is shown. According to the needs of focusing and imaging, the adjuster medium including multiple sheets with the same or different adjusting values is loaded between the object and the focusing unit. As shown in FIG. 5A, the adjuster medium group has five sheets of adjuster medium stacked together. Area a is positioned outside the optical path, area b is positioned inside the optical path, and each sheet of the adjuster medium may be moved to be projected from area a to area b. By loading the adjuster medium of different combination into the optical path, the adjuster medium is able to provide appropriate adjusting values. Furthermore, the adjuster medium may have different adjusting values, materials or thickness for different portions. Referring to FIG. 5B, an adjuster medium with ladder structure of an image capturing apparatus according to an embodiment of the invention is shown. The ladder-structured adjuster medium has a portion 1, a portion 2 and a portion 3. Each portion is made of the same material with different thickness, and is applicable to objects having different distances from the flatbed. By loading an appropriate portion of the adjuster medium into the optical path, an appropriate adjusting value is provided without having to replace the adjuster medium. Moreover, the manufacturing of the adjuster medium is made easier and even convenient.

The image capturing apparatus disclosed in the above embodiments of the invention is applicable to various types of image capturing apparatuses such as scanner, printer, facsimile machine, copy machine and multi-function machine. The invention adjusts the object distance or the image distance by the design incorporating an adjustable focusing unit and an adjuster medium, such that the images of the objects (including the positive film or negative carried on a film holder) with different object distances can be captured and that the CIS is enabled to have a depth of field larger than +/−0.3 mm.

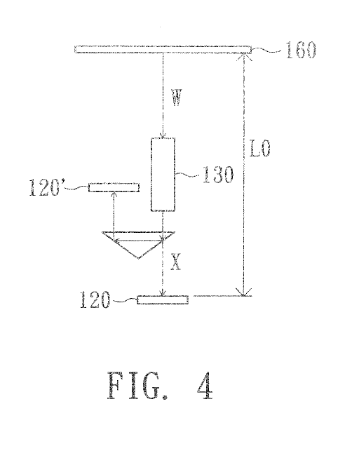

Despite the relationships between the elements are elaborated by physical positions in the above disclosures, however, in practical application, the optical path is changed by the reflection and refraction of the light, such that the dispositions of the elements are more flexible and more space is saved. Referring to FIG. 4, an optical path of an image capturing apparatus according to an embodiment of the invention is shown. The optical sensing unit 120 is shifted to the optical sensing unit 120′ via the refraction of the light. Despite the relationship of physical disposition changes, the relative disposition in the optical path still remains consistent. The relationship of physical disposition of elements can be replaced by the relative relationship in the optical path and still remains corresponding to the above disclosure and within the scope of protection of the invention. Similar changes have several types and are not limited to the embodiments and examples disclosed above.

The above embodiment in FIG. 4 is exemplified by a reflective light source. That is, the light generated by the object is reflected from the light source. In practical application, a transmission type light source can be adopted. That is, the light generated by the object is penetrated from the light source. The design of the transmission type light source is sometimes separated from the design of the image capturing apparatus. Some apparatuses have both a reflective light source and a transmission type light source, so that different light sources are adopted for different objects.

The first embodiment and the second embodiment disclosed above are exemplified by commonly used transparent flatbed. In some applications, the flatbed does not have to be involved with an optical path and can be made of a non-transparent material. For example, when the flatbed of an image capturing apparatus is positioned at the bottom most part, the object is placed on the flatbed, the focusing unit and the sensing element are disposed above the object, and hence the flatbed is not involved with the optical path.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image capturing apparatus, comprising:
a flatbed for carrying an object;
an optical sensing unit;
a focusing unit;
a light source for illuminating the object to generate an optical signal, wherein the optical signal forms an optical path from the object to the focusing unit first and then to the optical sensing unit next; and
an adjuster medium, wherein when the object and the optical sensing unit are spaced by a first distance L1, the adjuster medium is disposed outside the optical path, and the object and the focusing unit are spaced by a second distance L2, when the object and the optical sensing unit are spaced by a third distance L3, the adjuster medium is disposed in the optical path, and the object and the focusing unit are spaced by a fourth distance L4, such that the focusing unit focuses the optical signal on the optical sensing unit to generate an image signal.

2. The image capturing apparatus according to claim 1, wherein the light source comprises a light guiding element for guiding a point light source to be a uniformed line light source.

3. The image capturing apparatus according to claim 1, wherein the focusing unit is a self-focus lens array.

4. The image capturing apparatus according to claim 1, wherein the optical sensing unit is a contact image sensor (CIS).

5. The image capturing apparatus according to claim 1, wherein the third distance L3 and the first distance L1 are differed by a height d, the adjuster medium has a thickness H and a refractive index n, and the thickness H, the refractive index n and the height d satisfy: H*(1−1/n)=d.

6. The image capturing apparatus according to claim 5, wherein when the adjuster medium is disposed in the optical path, the adjuster medium is configured between the object and the focusing unit.

7. The image capturing apparatus according to claim 6, wherein the thickness H of the adjuster medium and the fourth distance L4 satisfy: H≦L4.

8. The image capturing apparatus according to claim 5, wherein the focusing unit is movably disposed in the optical path.

9. The image capturing apparatus according to claim 8, wherein the position of the focusing unit in the optical path is adjusted such that the fourth distance L4 is equal to the second distance L2, and the adjuster medium is configured between the focusing unit and the optical sensing unit in the optical path.

10. The image capturing apparatus according to claim 1, wherein the adjuster medium is made of glass or acryl.

11. The image capturing apparatus according to claim 1, wherein the adjuster medium includes multiple sheets having the same or different adjusting values.

12. The image capturing apparatus according to claim 1, wherein the adjuster medium has different adjusting values at different portions.

13. The image capturing apparatus according to claim 12, wherein the adjuster medium is a ladder structure made of the same material.

14. A focusing method of image capturing apparatus, wherein the image capturing apparatus at least comprises a flatbed, a light source, an optical sensing unit, and a focusing unit, the method comprising:
placing an object above the flatbed, wherein the object and the flatbed are spaced by a height d;
loading an adjuster medium to an optical path between the object and the optical sensing unit to adjust an object distance or an image distance of the object;
illuminating the object to output an optical signal by the light source; and
the optical signal passing through the focusing unit and the adjuster medium for being focused on the optical sensing unit.

15. The focus adjusting method according to claim 14, wherein when the adjuster medium adjusts the object distance of the object, the step of loading the adjuster medium comprises:
positioning the adjuster medium in the optical path between the object and the focusing unit.

16. The focus adjusting method according to claim 14, further comprising:
moving the focusing unit towards the object to adjust the object distance.

17. The focus adjusting method according to claim 16, wherein when the adjuster medium adjust the image distance of the object, the step of loading the adjuster medium comprises:
positioning the adjuster medium in the optical path between the focusing unit and the sensing unit.

18. The focus adjusting method according to claim 16, wherein the focusing unit is moved towards the object by a distance d.
